(19) United States
(12) Patent Application Publication
(10) Pub. No.: US 2010/0051011 A1
(43) Pub. Date: Mar. 4, 2010

(54) VENT HOOD FOR A COOKING APPLIANCE

(76) Inventor: Timothy Scott SHAFFER, LaGrange, KY (US)

Correspondence Address: General Electric Company;GE Global Patent Operation, PO Box 861, 2 Corporate Drive, Suite 648, Shelton, CT, 06484, US

(21) Appl. No.: 12/203,444

(22) Filed: Sep. 3, 2008

(51) Int. Cl. F24C 15/20; H01T 19/02

(52) U.S. Cl. 126/299 D; 250/326

(57) ABSTRACT

A vent hood is disclosed. The vent hood includes an enclosure having an inlet and a fluid passage, a first stage fluid moving device disposed adjacent to the inlet and configured to provide a substantially uniform inflow of fluid across the inlet, and a second stage fluid moving device disposed within the enclosure and downstream of the first stage fluid moving device.

### BACKGROUND OF THE INVENTION

The exemplary embodiments of the present invention generally relate to vent hoods. More particularly, the exemplary embodiments relate to multi-stage vent hoods for cooking appliances.

Generally conventional vent hoods for use with a cooking appliance include large blowers that may create airflow of 500 CFM (cubic feet per minute) to 1250 CFM. These vent hoods are designed to pulls odors and smoke coming from a cooktop of the cooking appliance into an overhanging enclosure above the cooktop. The blowers of these conventional vent hoods are generally large and provide high airflow rates so that the odors and smoke are adequately captured above all areas of the cooktop. However, the capture in the center of the vent hoods is disproportionately better than around the periphery of the vent hood. In many cases odor and smoke capture around the periphery of the vent hood can be quite minimal. The large blowers also produce high levels of noise that may generally be above 6-7 sones.

Generally conventional vent hoods have non-uniform capture patterns such as those described above. The airflow takes a path of least resistance into the vent hood, which is generally the path closest to the blower intake. Some vent hoods have blocked off the flow nearest the blower intakes to force air to flow around or near the perimeter of the vent hood, however, blower size is generally increased to accommodate the larger inlet pressure drop which can increase the operating noise levels of the vent hood.

### BRIEF DESCRIPTION OF THE INVENTION

As described herein, the exemplary embodiments overcome one or more of the above or other disadvantages known in the art.

One aspect of the exemplary embodiments relates to a vent hood. The vent hood includes an enclosure having an inlet and a fluid passage, a first stage fluid moving device disposed adjacent to the inlet and configured to provide a substantially uniform inflow of fluid across the inlet, and a second stage fluid moving device disposed within the enclosure and downstream of the first stage fluid moving device.

Another aspect of the exemplary embodiments relates to a method for venting air from a first area with a vent hood system. The method includes drawing the fluid into the vent hood system with a first stage fluid moving device disposed adjacent to an inlet of the vent hood system, supplying the fluid drawn by the first stage fluid moving device to a second stage fluid moving device, and exhausting the fluid from the vent hood system with the second stage fluid moving device through an exhaust outlet of the vent hood system to a second area remote from the first area.

Still another aspect of the exemplary embodiments relates to a multi-stage vent hood system for a cooking appliance. The multi-stage vent hood system includes a vent hood having an intake, an outlet, and a fluid flow pathway extending from the inlet to the outlet; a first stage fluid moving device disposed adjacent to the inlet and configured to draw fluid from a cooking area of the cooking appliance through the inlet into the vent hood; and a second stage fluid moving device disposed within the vent hood, downstream of the first stage fluid moving device, the second stage fluid moving device being configured to exhaust the fluid drawn by the first stage fluid moving device through the outlet.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIG. 1 is an illustration of a vent hood in accordance with an exemplary embodiment;

FIG. 2 is a schematic perspective view of a portion of a vent hood in accordance with an exemplary embodiment;

FIG. 3A is a schematic, perspective sectional view of the vent hood of FIG. 2;

FIG. 3B is a schematic, exploded view of a modified version of the vent hood of FIG. 2; and

FIG. 4 is a schematic, perspective sectional view of a vent hood in accordance with an exemplary embodiment.

### DETAILED DESCRIPTION OF THE EXEMPLARY EMBODIMENTS OF THE INVENTION

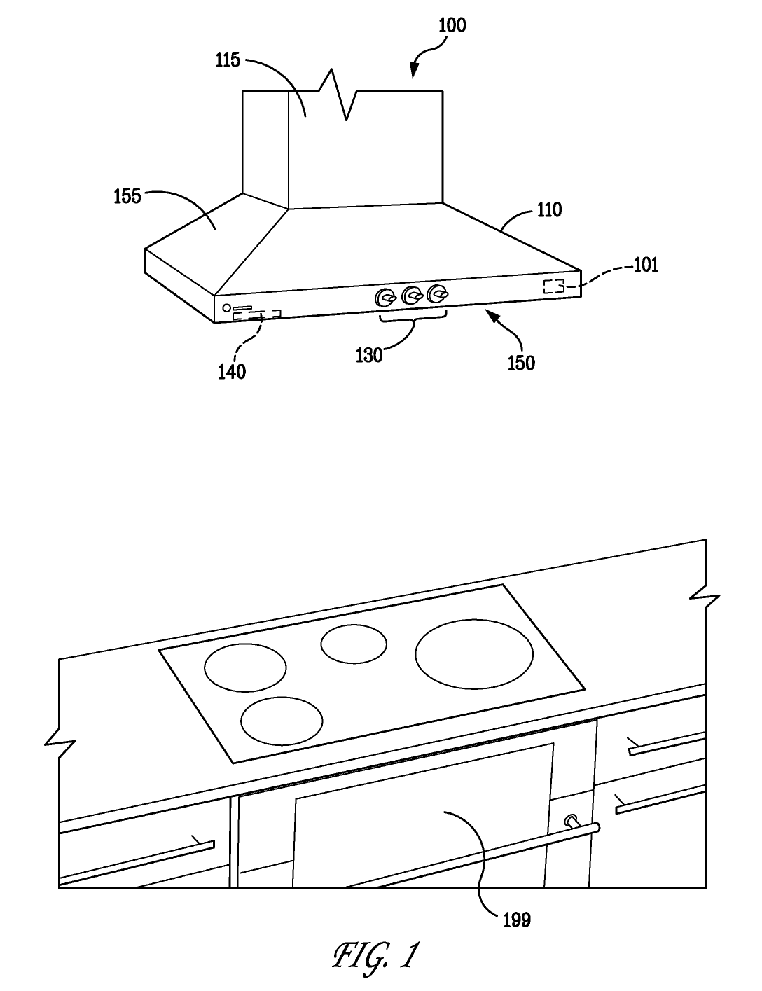

FIG. 1 illustrates an exemplary vent hood system 100 in accordance with an exemplary embodiment, installed over a cooking appliance 199. By way of example only, the vent hood system 100 is shown as a wall mount vent hood. However, the exemplary embodiments described herein may be used in other types of vent hoods including, but not limited to, island mount vent hoods and vent hood inserts as well as downdraft vent systems. The vent hood system may be used with any suitable cooking appliance including, but not limited to, gas or electric stoves/ovens, grills and fryolators. The vent hood system and corresponding mounting structure may be configured to accommodate any suitable ceiling height such as, for exemplary purposes only, ceiling heights of about eight to about ten feet.

In the exemplary embodiments, the vent hood system 100 includes two stages of fluid moving devices. The first stage of fluid moving devices may be located at an inlet of the vent hood system 100 and be configured such that the fluid intake through the inlet is substantially uniform over the entire area of the inlet. It is noted that the term “fluid” as used herein is used in a general sense and is meant to include any suitable fluids such as, but not limited to, air, steam, vapors, smoke, airborne grease and airborne particles. The first stage of fluid moving devices may include multiple fluid moving devices that individually move a lesser amount of fluid than would be required if a single fluid moving device was used, while the collective amount of fluid moved by the multiple fluid moving devices provides a fluid capture efficiency equal to or greater than conventional vent hoods. These lower flow rates allow for less noise production during operation of the vent hood system when compared to the noise produced by a single fluid moving device. The first stage of fluid moving devices is configured to supply fluid to the second stage of fluid moving devices, which may be located at any suitable location downstream of the first stage. While the exemplary embodiments are described herein with respect to two stages of fluid moving devices, it should be understood that in alternate embodiments the vent hood system 100 may include more than two stages of fluid moving devices. The multiple stages of fluid moving devices of the vent hood allow for lower operating speeds of the downstream fluid moving devices. Lower operating speeds of the downstream fluid moving devices translate into lower noise emissions generated during operation of the vent hood system 100. The multiple stages of fluid moving devices also allows for smaller and/or less powerful downstream fluid moving devices when compared to conventional vent hood blowers as the size and/or blowing capacity of the second stage fluid moving devices is not dependent or based on fluid capture requirements.

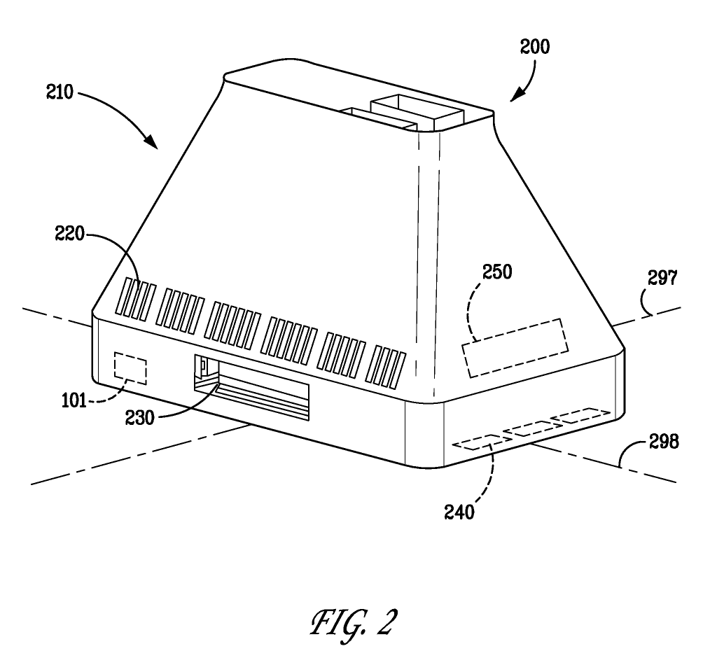

As can be seen in FIG. 1, the vent hood system 100 includes an enclosure 110 and a duct 115, which may be constructed of any suitable material or combination of materials including, for example, stainless steel, brass, bronze and/or copper. The enclosure 110 is shown in the figures as having a general rectangularly shaped base or inlet 150 and is configured to house one or more of the fluid moving devices of the first and second stages as will be described in greater detail below. In alternate embodiments, the enclosure can be any suitably shaped enclosures other than including a rectangular shape. The base 150 is connected to the duct through side portions 155 that extend towards the duct 115 in a tapered manner to form a fluid passage so that fluid entering the base 150 is directed through the tapered portion of the enclosure 110 into the duct 115. While the vent hood system 100 is shown in the figures as having a generally symmetrical configuration with respect to the lateral centerline 297 and longitudinal centerline 298 (see FIG. 2) of the vent hood system 100, in alternate embodiments the vent hood system may have an asymmetrical configuration. In other alternate embodiments the enclosure may include internal ducting that is housed by the enclosure 110 that directs the flow of fluid into the duct 115. The duct 115 in this exemplary embodiment may direct the captured fluid to any suitable remote location such as, for example, outside a building structure or room in which the vent hood system 100 is located. In other exemplary embodiments, the enclosure 110 may also be configured to selectively recirculate the captured fluid back into the cooking area as described below with respect to FIG. 2. It should be understood that the vent hood system 100 includes suitable screens and filters for filtering odors, smoke and other vapors or particles generated while cooking with the cooking appliance 199 from the fluid flowing through the vent hood system as will be described in greater detail below. It is noted that the filters/screens of the vent hood systems described herein may be removed from the vent hood systems and cleaned in any suitable manner such as for example, by washing in a dishwasher.

While the base 150 and the duct 115 are described and shown in the figures as having a substantially rectangular shape, it should be understood that the base 150 and/or duct may have any suitable shape and/or cross section configured for capturing heat, odors, smoke and other vapors or particles generated while cooking with the cooking appliance 199. It should also be understood that the base 150 may be suitably sized so that the base 150 has substantially the same dimensions as the cooktop surface of the cooking appliance with which the vent hood system 100 is used. In alternate embodiments the vent hood may cover an area larger or smaller (where only a portion of the cooking area requires a vent hood system) than the cooktop surface.

The vent hood system 100 may also include suitable lighting for illuminating the cooking area. The lighting may include one or more lighting modules or units 140. The lighting units 140 may include any suitable lighting such as, for example, incandescent bulbs, fluorescent bulbs and/or light emitting diodes (LED). In one exemplary embodiment, the lighting units 140 may include six LED lighting units. Each LED lighting unit may include a cluster of any suitable number of LEDs. The lighting units 140 may be suitably located on or around the vent hood for lighting the cooking area. For example, the six LED lighting units may be located along the periphery of the base 150 while in other examples, there may be LED lighting units located on supports that span the inlet of the vent hood system. In alternate embodiments, there may be more or less than six lighting units. The lighting units may be configured to provide any suitable number of lighting levels or intensities. For example, in one exemplary embodiment, there may be six lighting levels that are controllable through, for example, control panel 130. In alternate embodiments, the lighting units may have more or less than six lighting levels or intensities. In other exemplary embodiments the lighting units 140 may be configured in zones where each zone is individually operable or adjustable in light intensity. For example, the zones may include a right and left side of the vent hood, areas corresponding to cooking appliance burner locations, a front and back of the vent hood or any combination thereof.

The control panel 130 of the vent hood system 100 may be located in any suitable location for controlling the operation of the vent hood 100. In one example, as shown in FIG. 1, the control panel may be mounted on the enclosure 110 such as, for example, on the base 150. In alternate embodiments the control panel 130 may be located remotely from the enclosure 110. For example, the control panel 130 may be located on a counter surface, on the cooking appliance or any other suitable location within reach of a user. When located remotely from the vent hood enclosure 110, the control panel 130 may be connected to the vent hood components through a wired or wireless connection. The control panel 130 may be configured to turn on/off or adjust any suitable number and/or combination of the lighting units 140 (or zones of lighting units) as described above. The control panel 130 may also be configured to control the intake units of the vent hood individually or in groups as will be described in greater detail below. The control panel 130 may also include any suitable display or other graphical indicators to indicate an operational status of the vent hood system 100 such as, for example, the lighting intensity by zone, fan/blower speeds, a state of the filters/screens, recirculation or exhaust mode (as will be described below) indication and a temperature indication.

The vent hood system 100 may also include suitable sensor(s) 101 for automatically activating the fluid moving devices of the vent hood system 100. In one exemplary embodiment the sensor(s) 101 may be configured to sense items such as one or more of heat, smoke, odors and other vapors or particles generated while cooking with the cooking appliance 199. The sensor(s) 101 may be connected to the control panel 130 so that when the sensor(s) 101 detect one or more of the items a controller of, for example, the control panel 130 automatically activates the fluid moving devices of the vent hood system 100 as described herein. The sensor(s) 101 may also be configured to detect an amount and/or intensity of the items and adjust, for example, a speed of the fluid moving devices depending on the amount and/or intensity of the item(s) detected.

Referring now to FIG. 2, another exemplary vent hood system 200 is shown. The vent hood system 200 may be substantially similar to the vent hood system 100 described above unless otherwise noted. As such, like features have like reference numerals. In this exemplary embodiment, the vent hood system 200 includes an enclosure 210, light modules or units 240 and a control panel 230 similar to those described above. The vent hood system 200 in this exemplary embodiment also includes a recirculation vent grill 220 for selectively directing the fluid drawn into the vent system through the inlet area back into the area (e.g. kitchen or other suitable area) where the vent hood system 200 is located. In this exemplary embodiment the vent grill 220 includes any suitable number of slots located through a side of the enclosure 210. Here the vent grill 220 is integral or of unitary one-piece construction with the enclosure 210, but in alternate embodiments the recirculation vent grill 220 may be removable from the enclosure 210. In other examples, the vent grill 220 may also include louvers for controlling the direction of fluid flow exiting the vent grill 220 and/or odor absorbing filters for filtering fluid passing through the vent grill 220. In this exemplary embodiment, the vent hood system 200 may include suitable flow controls 250 such as dampers or valves that are configured to selectively direct the fluid captured by the vent hood system 200 back into the cooking area or into ductwork, such as the duct 115 described above, for removal from the cooking area. It is noted that the vent hood system 200 may be suitably configured such that when the vent hood system 200 is operating in an exhaust mode the captured fluid does not escape through the vent grill 220. The flow controls 250 for directing the captured fluid may be actuated in any suitable manner such as through, for example, control panel 230. For example, the flow controls 250 may be manually actuated through levers and the like or electrically actuated by suitable drive mechanisms through, for example, a touch interface of the control panel 230. In alternate embodiments, dampers may not be needed for directing the captured fluid back into the cooking area through the grill 220. For example, the second stage of fluid moving devices may be configured such that when the vent hood system 200 is in a recirculation mode, the second stage of fluid moving devices substantially does not allow fluid to pass or leak by the second stage, thereby effectively blocking the exhaust duct and causing the fluid moved by the first stage of fluid moving devices to exit the venting system through the recirculation vent grill 220.

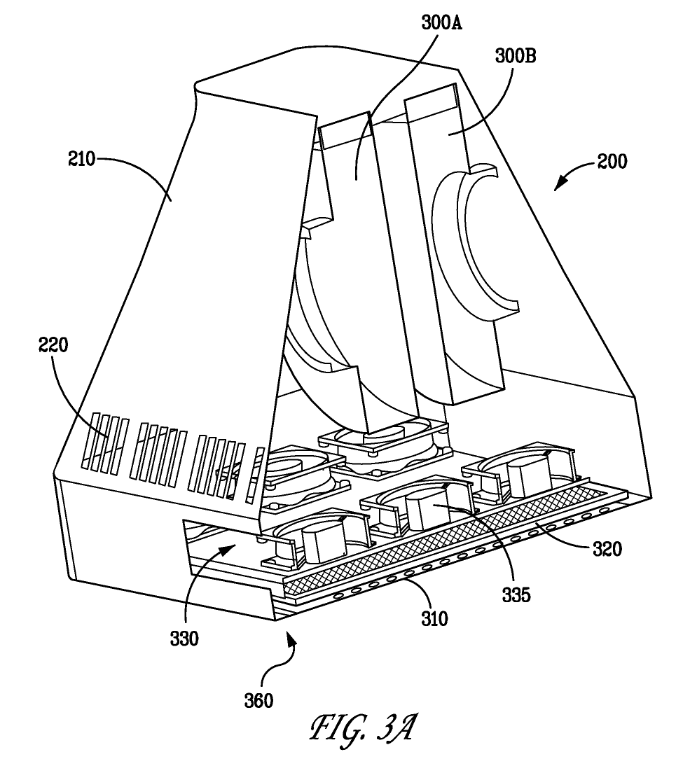

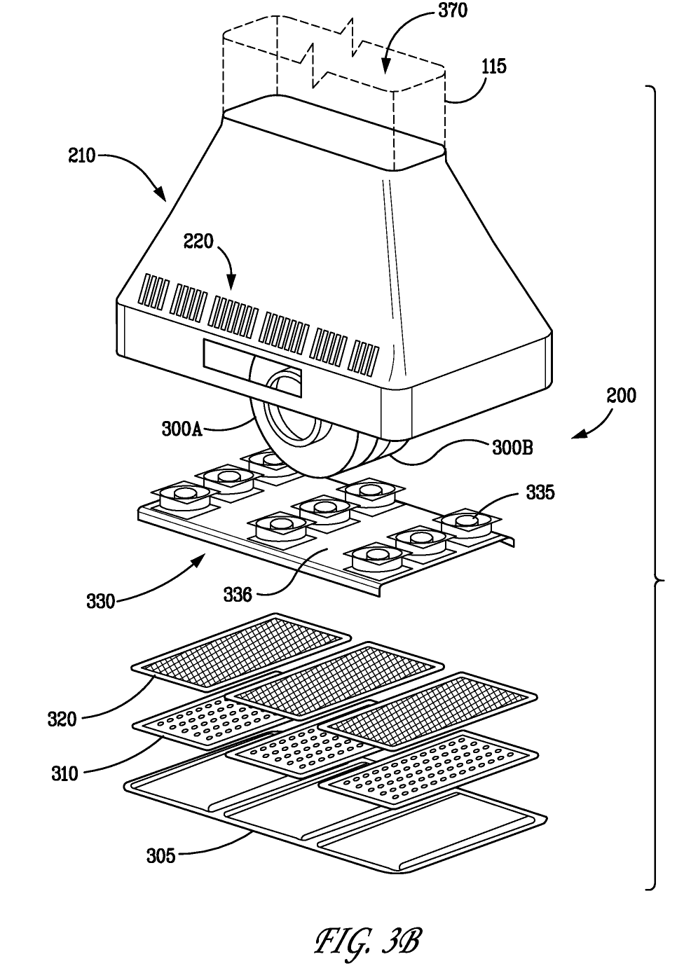

A cross sectional view of the vent hood system 200 is shown in FIG. 3A while an exploded perspective view of the vent hood system 200 is shown in FIG. 3B. As can be seen in FIGS. 3A and 3B, the vent hood system 200 includes a first stage having a fan array 330, a second stage having one or more air blowers 300A, 300B, one or more filters 320, one or more grease screens 310 and a screen holder 305. In this example, two blowers 300A, 300B are shown but in alternate embodiments there may be more or less than two blowers. The blowers 300A, 300B may be any suitable blowers including, but not limited to, axial, centrifugal and cross flow blowers. In this exemplary embodiment the blowers 300A, 300B may be suitably mounted within the enclosure 210 for directing captured fluid into the duct 115 for removal from the cooking area. In alternate embodiments the blowers 300A, 300B may be configured to selectively direct the captured fluid so that it flows through the recirculation vent grill 220 back into the cooking area. The blowers 300A, 300B may be mounted within the enclosure 210 using suitable isolators so that transfer of blower noise and vibrations to the enclosure 210 are minimized or eliminated. It should be understood that while the blowers 300A, 300B are shown located within the enclosure 210 in alternate embodiments the one or more blowers may be suitably located downstream of the enclosure 210 such as for example, within the duct 115 or in a blower unit located outside the cooking area such as on the roof of a building, mounted to the exterior of a building, on the ground within or outside the building or within a ceiling or wall of the building. It is noted that in one exemplary embodiment backdraft preventing damper assemblies may be provided in, for example, the duct 115 or any other suitable part of the vent hood system 200.

The fan array 330 may be suitably mounted within the enclosure 210 between the one or more blowers 300A, 300B (e.g., upstream of the blowers) and the intake 360 (e.g., downstream of or at the intake 360). In this exemplary embodiment the fan array 330 may include a fan mount 336 suitably sized and shaped to be affixed within the enclosure 210 with any suitable mechanical or chemical fasteners including, but not limited to, welding, screws and adhesives. In one exemplary embodiments the fan array 330 may be releasably mounted within the enclosure 210 so that the fans of the fan array 330 and the blowers 300A, 300B may be accessed for service and/or replacement. The fan array 330 may include any suitable number of fans 335, which are mounted to the fan mount 336 in any suitable manner. In one exemplary embodiment, the fan array 330 may include between six and twelve fans while in alternate embodiments the fan array may include less than six or more than twelve fans. As a non-limiting illustrative example, an array of six fans 335 is shown in FIG. 3A while an array of nine fans 335 is shown in FIG. 3B. In one exemplary embodiment the fans 335 may be releasably mounted to the fan mount 336 so that each fan may be replaced or serviced individually or collectively. The fans 335 may be any suitable fans which are located on the fan mount 336 such that the fluid pulled by the fan array is substantially uniform across the intake 360 (e.g. the amount of fluid pulled in along the periphery is substantially the same as the amount of fluid pulled in at the center of the intake or inlet). The fans may be located within the enclosure 210 such that they are placed above and around the perimeter of the cooking surface so that fan flow requirements are reduced without reducing the capture of heat, smoke, odors or other particles generated during cooking. In one example, the fans 335 may be muffin or box fans. Each of the fans 335 may have any suitable flow rating so that collectively the fans can remove a predetermined amount of fluid (which may depend on the size of the cooking appliance used in conjunction with the vent hood) from the cooking area. The fan array 330 may be configured to pull fluid from the cooking area into the enclosure 210. The fan array 330 may be divided into zones substantially similar to the zones described above with respect to the lighting units 140 so that each zone of fans may be operated individually or in any combination thereof.

The one or more filters 320 are located upstream of the fan array 330 and may be configured to capture or filter odors and smoke from the fluid flow passing through the enclosure 210. In alternate embodiments the filters 320 may be located downstream of the fan array 330 at, for example, the recirculation vent grill 220. The one or more grease screens 310 may be located upstream of the filters 320 for capturing, for example, airborne grease. The fitters 320 and grease screens 310 may be held within the enclosure 210 at the intake 360 in any suitable manner by the screen holder 305. The screen holder 305 may be coupled or attached to the enclosure 210 in any suitable releasable manner so that the screens 310 and filters 320 can be cleaned and/or replaced.

In operation the vent hood system 200 may be selectively operated in one of a recirculation mode (e.g., where the fluid pulled from the cooking area is returned to the cooking area) or an exhaust mode (e.g., where the fluid pulled from the cooking area is exhausted through the duct 115 to an area remote from the cooking area). In the recirculation mode of operation, the fan array 330 may cause the filtered fluid flow to pass from the enclosure 210 through the recirculation vent grill 220 back into the cooking area. The fans 335 effect reduced noise levels during operation in the recirculation mode. For example, muffin fans in flow regions less than 90 CFM can have sound levels of less than about 36 dBA so that the maximum operating noise level of the vent hood system 200 in the recirculating mode is about 1 sone or less.

In an exhaust mode of operation, the fan array 330 (e.g. the first stage of venting) may direct or supply fluid to the downstream blowers 300A, 300B (e.g. second stage of venting) for removal from the cooking area through an outlet 370. The two stage venting allows for operation of the downstream blowers 300A, 300B at a lower speed when compared to conventional vent hoods having blowers that do not include supply fans such as fans 335 (e.g. the first stage of venting). These lower blower speeds effect reduced noise levels during operation of the vent hood system 200 in the exhaust mode. For example, the vent hood system 200 may be configured operate at a noise level in the exhaust mode of about 2 sones or less. In addition the blower size may also be reduced as the size of the blower(s) 300A, 300B are based on a desired noise level/specification of the vent hood system 200 rather than on fluid capture requirements at the vent hood inlet.

In one exemplary embodiment, and for exemplary purposes only, where the vent hood system is configured for operation with a 36 inch wide cooking appliance, the fan array may be configured for an average fluid flow rate of about 400 CFM of fluid at about 0.0 water column (W.C.) static pressure. In alternate embodiments the average fluid flow rate generated by the fan array may be more or less than 400 CFM depending on, for example, a size of the corresponding cooking appliance. In one exemplary embodiment where the vent hood system is configured for operation with a 36 inch wide cooking appliance the one or more blowers may be configured for an average fluid flow rate of about 650 CFM of fluid at 0.0 W.C. static pressure. In one exemplary embodiment the vent hood system 200 may be configured to accommodate about 60,000 BTU/hr of cooking surface operation and common size indoor grill operation. In alternate embodiments the vent hood may be configured to accommodate more or less than 60,000 BTU/hr of cooking surface operation. It is noted that the above-noted flow rates and static pressures are given by way of example only and are not intended to limit the scope of the exemplary embodiments.

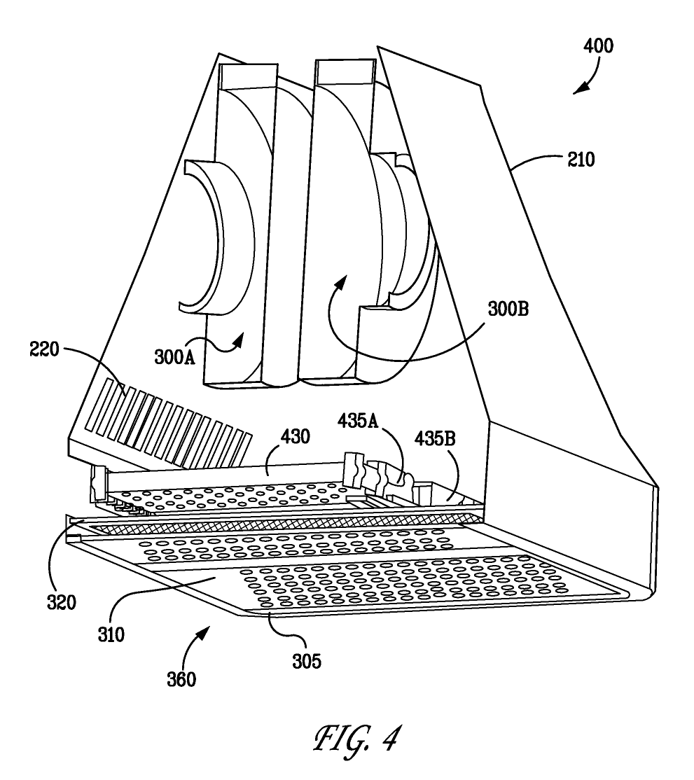

Referring now to FIG. 4, another exemplary embodiment of a vent hood system 400 is shown. The vent hood system 400 is substantially similar to the vent hood systems described above with respect to FIGS. 1-3B unless otherwise noted. As such, like features have like reference numerals. In this example the first stage of the vent hood system 400 includes any suitable number of electrostatic modules 430. In this exemplary embodiment the first stage includes two electrostatic modules 435A, 435B, but in alternate embodiments there may be more or less than two electrostatic modules. The electrostatic modules 430 are configured to generate fluid flow into the intake 360 (e.g., draw fluid in from the cooking area) by, for example, corona discharge. The electrostatic modules may be suitably sized and positioned at the vent hood intake 360 such that the fluid flow into the vent hood system 400 is substantially uniform over the entire area of the intake 360. In this exemplary embodiment, each of the electrostatic modules 430 generates about 0.5 CFM to about 1.0 CFM of fluid per square inch of module area. In alternate embodiments the electrostatic modules 430 may be configured to generate less than about 0.5 CFM and/or more than about 1.0 CFM per square inch of module area. The electrostatic modules 430 may also be configured to filter particles and odors from the fluid flow in any suitable manner including, but not limited to, the filters/screens described above and/or through, for example, particle ionization/attraction. In one exemplary embodiment, the electrostatic modules 430 may be configured to collectively move about 400 CFM of fluid into the intake 360. In alternate embodiments the electrostatic modules may be configured to move more or less than 400 CFM of fluid into the inlet depending on, for example, a size of the cooking appliance used with the vent hood system. Electrostatic modules are known (for example, they are used in air purification systems), and therefore will not be discussed in detail here.

The electrostatic modules 430 may include zones substantially similar to those described above with respect to the fan array 330 and lighting units 140 so that one or more of the zones can be operated, through for example the control panel 130, individually or in any suitable combination. The control panel 130 may also be configurable to indicate or remind a user that the filters/screens need cleaning. For example, the controller within the control panel 130 may be configured such that when the performance of the vent hood intake decreases to a predetermined flow rate, such as for example, about 200 CFM due to dirty filters/screens an audible or visual indicator will alert the user that the filters/screens are to be cleaned.

In a recirculation mode of operation substantially similar to that described above, the electrostatic modules 430 of the vent hood system 400 produce substantially zero noise emissions. In an exhaust mode of operation, the noise generated by the vent hood system 400 is substantially that of the second stage blowers which as describe above is about 2 sones or less.

It is noted that while the first stage of fluid moving devices are described herein as fans or electrostatic devices and the second stage of fluid moving devices are described as blowers, in alternate embodiments other suitable fluid moving devices or methods may be used.

The exemplary embodiments described above provide for a multi-stage vent hood system for use with, for example, cooking appliances. The multi-stage configuration of the vent hood allows for reduced blower size, which contributes to operation of the vent hood system at lower noise levels than conventional single stage vent hoods. The multi-stage vent hood system also provides for a substantially uniform flow of fluid over the entire area of the vent hood intake. Multiple modes of operation of the multi-stage vent hood system also allow users to select operation in one of a recirculation mode or an exhaust mode.

Thus, while there have been shown and described and pointed out fundamental novel features of the invention as applied to the exemplary embodiments thereof, it will be understood that various omissions and substitutions and changes in the form and details of devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A vent hood system comprising:
an enclosure having an inlet and a fluid passage;
a first stage fluid moving device disposed adjacent to the inlet and configured to provide a substantially uniform inflow of fluid across the inlet; and
a second stage fluid moving device disposed within the enclosure and downstream of the first stage fluid moving device.

2. The vent hood system of claim 1, wherein the first stage fluid moving device comprises an array of fans disposed substantially at the inlet for effecting the substantially uniform inflow of fluid across the inlet.

3. The vent hood system of claim 1, wherein the first stage fluid moving device comprises an electrostatic module disposed substantially at the inlet for effecting the substantially uniform inflow of fluid across the inlet.

4. The vent hood system of claim 1, wherein the second stage fluid moving device comprises a blower.

5. The vent hood system of claim 4, wherein the blower has a blowing capacity which is primarily determined by a noise level of the vent hood system rather than by a fluid drawing requirement of the vent hood system.

6. The vent hood system of claim 1, selectively operative in a exhaust mode and a recirculating mode, wherein the enclosure further comprises a fluid recirculation vent, the first stage fluid moving device and the fluid recirculation vent being configured in the recirculating mode to move fluid from an outside area of the enclosure into the enclosure through the inlet and move at least part of the fluid back to the outside area through the fluid recirculation vent.

7. The vent hood system of claim 6, further comprising a filter disposed within the fluid passage for filtering the fluid before the fluid is moved back to the outside area.

8. The vent hood system of claim 6, wherein the second stage fluid moving device is configured in the exhaust mode to move fluid from the enclosure through an exhaust duct to a remote exhaust outlet and in the recirculating mode to substantially block the exhaust duct.

9. The vent hood system of claim 1, wherein the enclosure has an exhaust outlet disposed downstream of the second stage fluid moving device, the first stage fluid moving device being configured to supply fluid to the second stage fluid moving device, the second stage fluid moving device being configured to exhaust the fluid through the exhaust outlet.

10. The vent hood system of claim 1, further comprising a lighting unit disposed adjacent to the inlet.

11. A method for venting fluid from a first area with a vent hood system, the method comprising:
drawing the fluid into the vent hood system with a first stage fluid moving device located adjacent to an inlet of the vent hood system;
supplying the fluid drawn by the first stage fluid moving device to a second stage fluid moving device disposed downstream of the first stage fluid moving device; and
exhausting the fluid from the venting hood system with the second stage fluid moving device through an exhaust outlet of the vent hood system to a second area remote from the first area.

12. The method of claim 11, wherein the first stage fluid moving device comprises an array of fans.

13. The method of claim 12, wherein the fans are distributed so that the fluid flow is substantially uniformly across the inlet.

14. The method of claim 11, wherein the first stage fluid moving device comprises an electrostatic module which moves the fluid through a corona discharge.

15. A multi-stage vent hood system for a cooking appliance, comprising:
a vent hood having an inlet, an outlet, and a fluid flow pathway extending from the inlet to the outlet;
a first stage fluid moving device disposed adjacent to the inlet and configured to draw fluid from a cooking area of the cooking appliance through the inlet into the vent hood; and
a second stage fluid moving device disposed within the vent hood, downstream of the first stage fluid moving device, the second stage fluid moving device being configured to exhaust the fluid drawn by the first stage fluid moving device through the outlet.

16. The multi-stage vent hood system of claim 15, wherein the first stage fluid moving device is configured to provide a substantially uniform inflow of fluid across the inlet.

17. The multi-stage vent hood system of claim 16, wherein the first stage fluid moving device comprises an electrostatic module.

18. The multi-stage vent hood system of claim 16, wherein the first stage fluid moving device comprises an array of fans which are distributed to provide substantially uniform inflow of fluid across the inlet.

19. The multi-stage vent hood system of claim 16, wherein the second stage fluid moving device comprises a blower.

20. The multi-stage vent hood system of claim 15, further comprising a fighting unit supported by the vent hood and disposed adjacent to the inlet.

21. The multi-stage vent hood system of claim 15, further comprising:
a controller connected to the first stage fluid moving device and the second stage fluid moving device; and
at least one sensor supported by the vent hood and connected to the controller, the sensor being configured to detect a predetermined condition and send a signal to the controller;
wherein upon receipt of the signal, the controller is configured to automatically activate the first stage fluid moving device and the second stage fluid moving device.

22. The multi-stage vent hood system of claim 15, further comprising a filter disposed in the fluid flow pathway.
